(19) United States
(12) Patent Application Publication
(10) Pub. No.: US 2006/0155851 A1
(43) Pub. Date: Jul. 13, 2006

(54) Networked home surveillance architecture for a portable or remote monitoring device

(75) Inventors: Yue Ma, West Windsor, NJ (US); Dennis Bushmitch, Somerset, NJ (US); Jingbo Zhu, Shenyang City (CN); Honglin Wu, Shenyang City (CN); Weiguo Zhu, Nanjing (CN)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/285,625

(22) Filed: Nov. 22, 2005

Related U.S. Application Data
(63) Continuation-in-part of application No. 10/894,469, filed on Jul. 19, 2004.
(60) Provisional application No. 60/524,599, filed on Nov. 25, 2003.

(51) Int. Cl. G06F 15/173

(52) U.S. Cl. 709/226

(57) ABSTRACT

A networked mobile home surveillance system includes a home surveillance application running on a user device to access services on a home network and receive data from the home network. A home network gateway uses SIP messaging to allow communication of commands and data on the user device to and from a home networked device through bridging between SIP and a non-SIP protocol of the home network. A home surveillance service on the home network controls home networked remote devices used to monitor the home, and is subject to control by the application.

### CROSS-REFERENCE TO RELATED APPLICATIONS

This application is a continuation-in-part of U.S. patent application Ser. No. 10/894,469 filed on Jul. 19, 2004 which claims the benefit of U.S. Provisional Application No. 60/524,599, filed on Nov. 25, 2003. The disclosures of the above applications are incorporated herein by reference in their entirety for any purpose.

### FIELD OF THE INVENTION

The present invention generally relates to web-based home surveillance technology and home security systems, and relates in particular to a home networked home surveillance service system and architecture for a portable or remote monitoring device.

### BACKGROUND OF THE INVENTION

Home surveillance is an emerging market for home security. The existing market for home surveillance is limited to burglar alarm and central station notification. This system requires monthly service fees and the system is proprietary; therefore, it involves huge cost associated with upgrading the systems.

In a different market, many networked home surveillance cameras are being sold on the market. These networked cameras are Internet capable and offer continuous monitoring of the home through web technologies. However, the cost of retrofitting these state of the art devices to the existing centralized home security systems is quite high.

The need exists for a way to integrate home surveillance cameras and web technology with home security systems. The present invention fulfills this need.

### SUMMARY OF THE INVENTION

In accordance with the present invention, a networked mobile home surveillance system includes a home surveillance application running on a user device to access services on a home network and receive data from the home network. A home network gateway uses SIP messaging to allow communication of commands and data on the user device to and from a home networked device through bridging between SIP and a non-SIP protocol of the home network. A home surveillance service on the home network controls home networked remote devices used to monitor the home, and is subject to control by the application.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating an architecture of a home surveillance system in accordance with the present invention;

FIG. 2 is a block diagram illustrating a SIP Stack implemented in a home network gateway in accordance with the present invention;

FIG. 3 s a block diagram illustrating a SIP Service for a home network gateway in accordance with the present invention;

FIG. 4 is a view of a home surveillance user interface component for configuring a home surveillance service in a home network and outputting an alarm notification in response to an alarm received from the service in accordance with the present invention;

FIG. 5 is a view of a home surveillance user interface component by which a user may select to view and control viewing of a video stream from a remote camera in accordance with the present invention;

FIGS. 6a and 6b are views of user interface components by which a user can configure camera settings and/or home surveillance settings in accordance with the present invention;

FIG. 7 is a block diagram illustrating interaction of a home surveillance application and mobile home SIP middleware in accordance with the present invention;

FIG. 8 is a flow diagram illustrating SIP signaling in accordance with the present invention; and

FIG. 9 is a block diagram illustrating a home surveillance bundle and SIP bridging in accordance with the present invention.

### DETAILED DESCRIPTION OF THE PREFERRED EMBODIMENTS

The following description of the preferred embodiments is merely exemplary in nature and is in no way intended to limit the invention, its application, or uses.

The system and architecture according to the present invention enables a home networked home surveillance service that is extendable and upgradeable through a home gateway. The service is based on a home network, which significantly reduces the cost for central security service providers. The service is further capable of notifying a remote user directly through SIP and providing a remote real-time monitoring service upon request.

Various embodiments of the present invention can enable and/or provide one or more of the following applications and features: (1) a home surveillance service can be upgraded, installed and run on a home network that is connected to a home gateway and other networked devices that can be accessed and controlled by any service on the network including home surveillance service; (2) a home surveillance service on the home network monitors home and detect multiple configurable events such as burglar, fire, intrusion, false alarm etc.; (3) a home surveillance service can either send a notification to the central station or directly to the user at a remote location upon the detection of events; (4) a user (or central station) can request additional services from home surveillance such as control the camera, triggering sprinkler system, making 911 calls to police station upon fire; etc.; and (5) a home surveillance system can send data and media (e.g. streaming from a camera) to the user at remote location or central station.

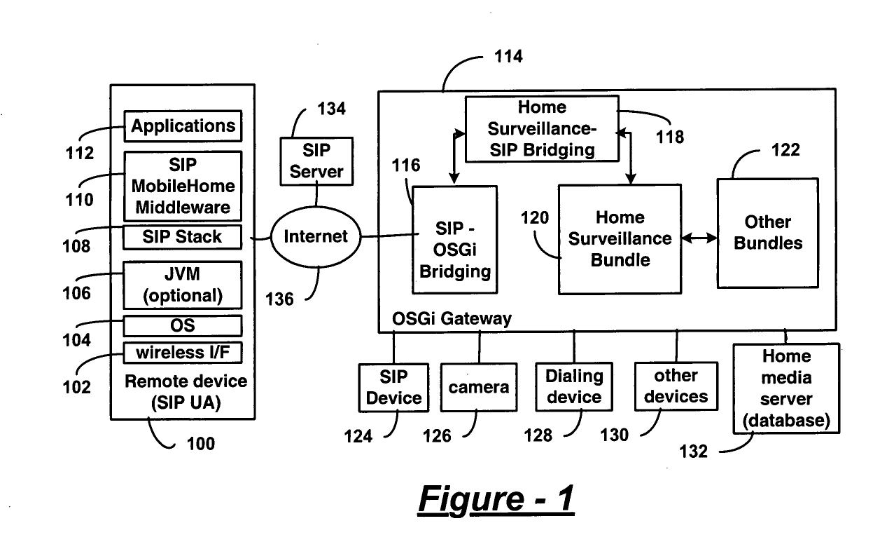

Referring to FIG. 1, a system architecture according to some embodiments of the present invention can be mainly of two parts: remote device; and home network. The architecture of such systems can be based on SIP-OSGi bridging.

The remote device 100 can include an operating system 104, a java virtual machine (JVM) 106, applications 112 with GUI, SIP middleware 110, network stack (SIP) 108, and wireless interface 102. It can communicate with the home network via SIP protocol. Therefore, the remote device can also act as a SIP UA (user agent) from SIP network perspective.

Home surveillance applications can be mobile, and can realize the scenarios described previously. The home monitoring application can be able to communicate with a home surveillance service installed on a home network (an OSGi bundle) and be able to receive alarms upon intruders and monitor the home through one or more networked cameras.

SIP stack can enable the mobile device with SIP. Depending on SIP implementation, a JVM may or may not be required.

SIP was originally designed as the protocol for multimedia session creation and termination with its intended use in Voice over IP. To use SIP in home networking applications, a middleware is needed to convert SIP signaling protocols to home networking specific functions. This middleware according to the present invention can be an internal library that receives messages from mobile applications in relation to home entertainment, and converts them to SIP commands. It can also receive SIP messages and events and send relevant messages to applications.

The purpose of building SIP middleware is two fold. One purpose is to simplify SIP signaling protocols for applications, and this middleware can be re-used in future applications. The second purpose is to make the mobile application independent of SIP, therefore providing flexibility to use protocols other than SIP protocols in the future, if needed. For example, if the remote device is equipped with OSGi framework in the future, SIP middleware can be replaced, but the applications do not need to be rewritten.

SIP server/proxy 134 according to the present invention can be an intermediary device that is located within the SIP-enabled network 136 and assists user agents in session establishment and other functions. It is a general term for SIP Proxy, redirect server, or registrar server.

OSGi gateway 114 according to the present invention can provide a basic framework for networked devices to be able to communicate and control each other. OSGi supports a variety of networks, such as UPnP, Jini, Http, etc.

The SIP-OSGi bridging 116 according to the present invention can be an adaptor to allow devices and services (applications) on the OSGi gateway to possess SIP capability that allows them to be able to communicate with other SIP devices in a remote location via SIP server/proxy. Home surveillance-SIP bridging 118 can interface a home surveillance service bundle 120 and other bundles 122 with SIP-OSGI bridging. SIP-OSGi bridging can be constructed in two ways.

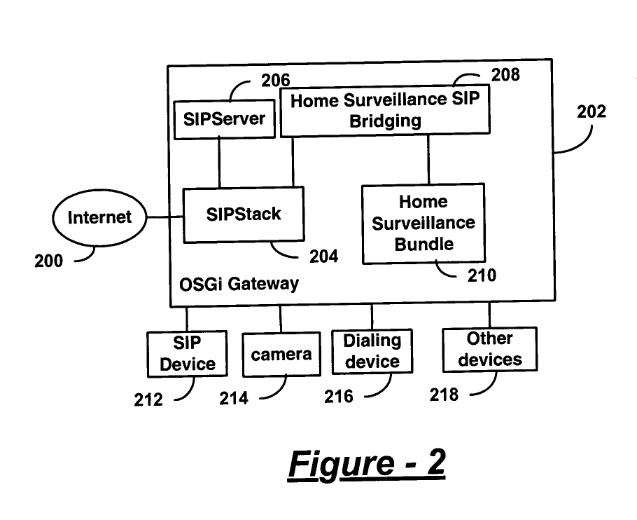

One way in which SIP-OSGI bridging can be constructed is referred to herein as SIP Stack Bundle on OSGi. Referring to FIG. 2, a SIP stack 204 can be retrofitted to the OSGi gateway 200 with a SIP server 206. Therefore, it can be rendered accessible by other OSGi applications (bundles), such as home surveillance bundle 210, through OSGi API (Application Program Interface). Home surveillance bridging 208 can interface home surveillance bundle 210 with SIP stack 204, while SIP stack 204 interfaces services and devices on the home network, such as devices 212-218, with SIP-enabled network 200.

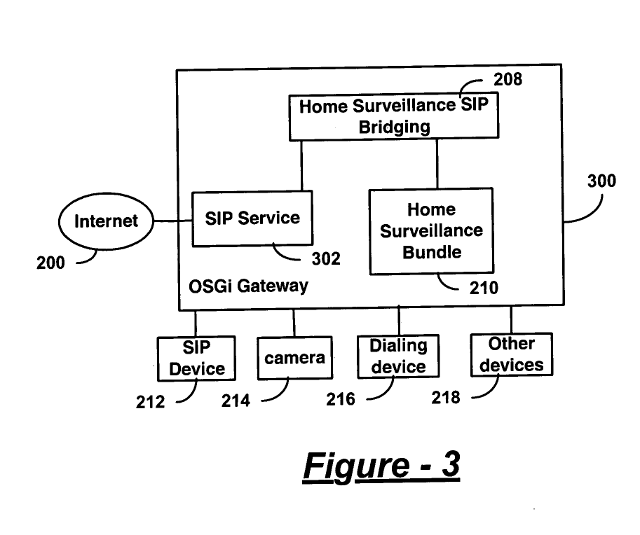

Another way in which the SIP-OSGI bridging can be constructed is referred to herein as SIP Service for OSGi. Turning now to FIG. 3, an OSGi package (bundle)—SIP Service 302, is designed to handle mobility and inter-gateway bridging of OSGi devices 212-218. SIP Service 302 is installed on gateway 300 and interfaced with network 200 and home surveillance-SIP bridging 208, which still connects to home surveillance bundle 210. SIP Service 302 provides the following functionalities, presently absent in OSGi framework, through its own SIP Service API: (1) WAN communication of SIP Devices, in which SIP protocol enables secure communication between the wide area mobile device and local devices and services that are connected and registered with OSGi home gateway; (2) OSGi device and service application-layer mobility, in which case selected OSGi devices/services can be exported as a SIP device and registered with SIP proxy/location service, thus gaining mobility feature of SIP to can move and register with another SIP server; and (3) OSGi inter-gateway bridging, in which case devices registered with one OSGi framework's registry are exported by bridging bundles as SIP devices and imported into a service registry of another OSGi framework as SIP devices, allowing one OSGi device on one network to be treated as a local device on another network.

The SIP Service is an extension of OSGi framework, and further details relating to the SIP service can be found in the present application's parent U.S. patent application Ser. No. 10/894,469 filed on Jul. 19, 2004, herein incorporated by reference in its entirety for any purpose. The SIP-OSGi bridging allows sharing and control of devices from outside a home via SIP service. Other services each implementing specific functions can also be installed and executed on the framework. For example, home surveillance service can be installed on the OSGi framework and utilized by devices or other bundle services on the network.

Home surveillance service provides home monitoring and surveillance. It can periodically access home security camera (e.g. a 1394 or UPnP network camera) and detect if there are any intruders. If any intruders are detected or extreme situations occur, an alarm can be sent off to the gateway middleware layer, which in turn can send an alarm to the registered SIP devices. Upon request from the registered remote device through mobile-home middleware, a streaming video session can be established for monitoring surveillance video on the remote device.

The SIP Bridging for home surveillance service 208 is provided within mobile-home middleware to allow other SIP devices to access or control home surveillance service or camera.

SIP Device bridging provides capabilities for home surveillance service to be able to control other OSGi or non-OSGi devices. For example, a SIP-UPnP bridging can convert SIP commands/messages/events to those of UPnP and therefore allow home surveillance service to control UPnP device (e.g. UPnP camera) on OSGi framework.

The home surveillance application registers the mobile device with the home surveillance service and is able to receive any alarms in case of burglars. In case of burglar, the application is also able to request establishment of video stream session with home surveillance service so video captured from the home security camera can be transmitted and displayed on the mobile device. Specifically, the function is composed of the following components: (1) a status window to display the status/response corresponding to each button item; (2) a video window having a quick button to display video images captured from the home surveillance networked camera as follows: (a) when an alarm is received from Home Surveillance Service, a message “Alarm!! Intruder detected!” can be displayed; (b) a user can request a real-time video session by clicking the “video” button; and (c) upon establishment of the video session, the status window displays “Real-time monitoring . . . ”; (3) a connect component that can be selected by a user to connect to SIP server (managed by SIP Service on the home network) and register with the home network, causing a list of services connected to be displayed, such as “Home Surveillance registered”; (4) a configure component that can be selected by a user to configure home surveillance service IP address (SIP Server address) and set services available for subscription, such as home surveillance service; (5) a control component that can be selected by a user to access/control home surveillance service, such as request video session, control camera action or parameters, and set system parameters such as sensitivity for detecting motions, etc.; (6) a disconnect component that can be selected by a user to cancel a video stream session; (7) an exit component that can be selected by a user to cancel a video stream session (if applicable), unregister with the SIP server, and quit the application.

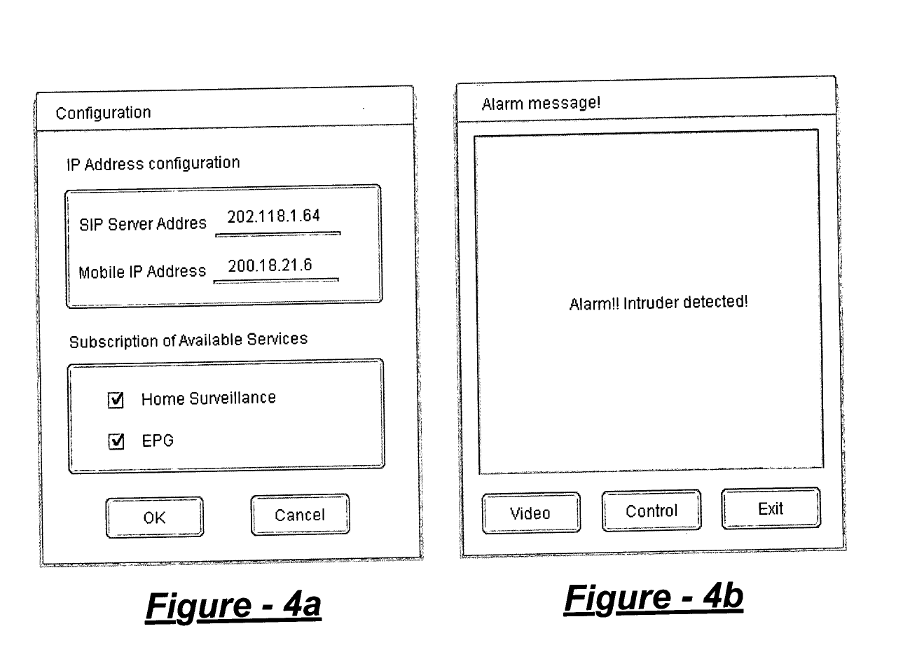

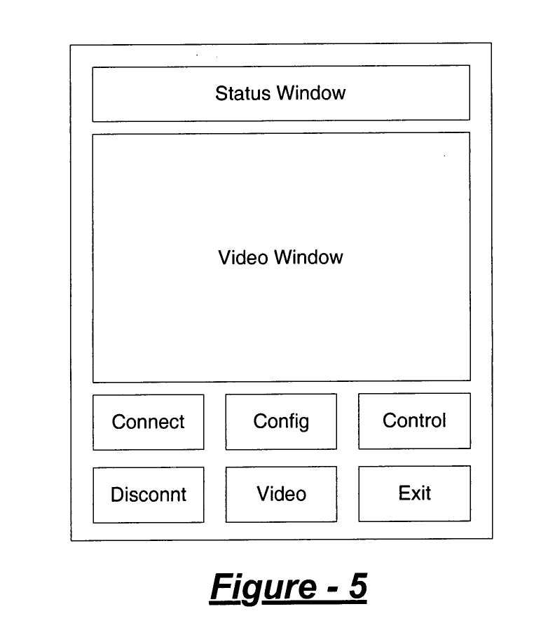

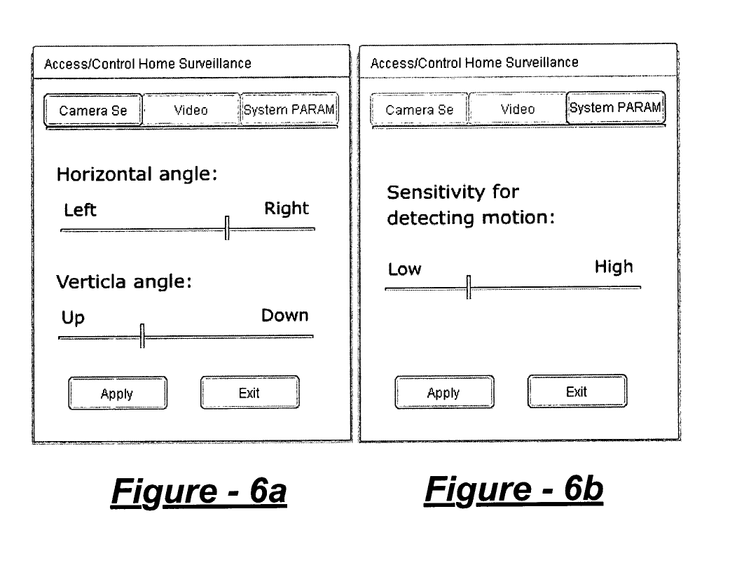

Continuing with FIGS. 4-6, the GUI application can include several GUI components. For example, upon start of the GUI application on a remote device, a configuration page is displayed and all available services are listed (FIG. 4a). Upon selection of Home surveillance service, the remote device subscribes an event to the home surveillance on the home network for burglar event. The home surveillance service continuously monitors the video captured from the camera and sends an alarm (notification) upon detection of the burglar. In such a case, a windows pops up on the remote device to alert the user (FIG. 4b). The user can select video to watch the real-time streaming (FIG. 5). Upon clicking “Control”, the user is able to configure the camera settings or home surveillance settings: the user also can adjust the angle of the camera (FIG. 6A) or the sensitivity for detecting motions (FIG. 6B).

As previously stated, SIP middleware is needed in order to convert SIP signaling protocols to home network flavor functions, and vice versa. Particularly, for home networking applications, several basic functions are needed: (a) register a mobile device with home network; (b) list the devices, services and events available on the home network; (c) subscribe to events on the home network, such system events (such as if new devices are added to the home network), and special events that are provided by devices or services on the network (such as an alarm sent from the home surveillance service); (d) send control commands to a device on the home network, such as “record” on a personal video recorder (PVR); (e) request and receive data from home network devices or services, such as data indicating the home monitoring status and status of other security devices; (f) start and terminate audio/video streaming session with an A/V device on the home network, such as connect to a SIP phone at home, or view video stream that is being captured from a security camera.

The SIP protocol provides the capability of device/service discovery, control, registration and events through methods like REGISTER, MESSAGE, and/or SUBSCRIBE. Both data and media stream need to be “carried” via SIP service. The challenge is that SIP can only carry a small message body, which is not suitable for a large chunk of data or streams of video. Therefore, the transport of data can be implemented in the following ways: (a) short messages such as request and control commands can be carried in SIP MESSAGE body as plain text, and these messages can be transparent to proxies and need to be interpreted at the SIP end point; (b) add additional information such as a chunk of data can be carried in a separate message body attachment as payloads, and it can be either text based or MIME type; and (c) RTP can then be used for media transport. The multimedia streaming session can be negotiated by applications, in SDP (session description protocol)—a simple text based protocol. This is supported by SIP and completely transparent to SIP.

Home surveillance service bundle is an application specific service that is packaged into OSGi bundles to be executed within OSGi framework from any requested devices/services. The home surveillance service constantly monitors video captured from a security camera, and sends an alarm to a registered listing device upon detection of intruders. It can include the following functions: (a) register device for capturing device; (b) capture and store video frames for processing; (c) detect intrusion based on video analysis (e.g., simple motion analysis can be used); (d) send an alarm to a registered device upon detection of intrusion; (e) receive commands to configure the service such as the sensitivity of alarm triggering, configure motion pattern for intrusion detection (in order to prevent certain false alarm from home pet); or establish real-time streaming between the mobile user device and a camera connected to the home network, etc.

Returning now to FIG. 1, the home surveillance service SIP bridging 118 functions as the bridging between home surveillance API and SIP API. Specifically, it: (a) registers with SIP server through SIP-OSGi bridging 116 and acts itself as a Home Surveillance SIP UA; (b) passes SIP messages to/from home surveillance service bundle; (c) registers a SIP listener with SIP server and sends an event to a remote device once an alarm is received from home surveillance service; (d) upon request from a remote device, establishes a media session between the remote device and the home surveillance service on the home network to monitor video captured from the camera.

The functional flow and message flow of remote applications according to a presently preferred embodiment can be described in terms of the application and SIP middleware, SIP messaging, and Java objects for remote applications. The functional flow and message flow of an OSGI gateway according to a presently preferred embodiment can be described in terms of home surveillance bundle and SIP bridging, and in terms of Java objects for home surveillance and SIP bridging.

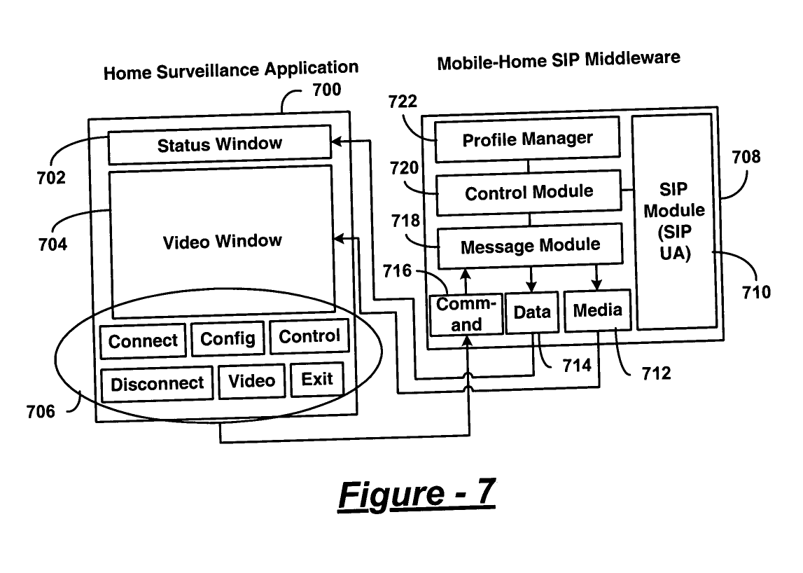

Referring now to FIG. 7, as far as application 700 and SIP middleware 708, mobile applications run on the mobile device and directly interact with end users via GUI. The applications take user's input from applications and translate to mobile-home middleware “protocols”. Applications also receive the results from middleware and display to the user via GUI. The following describes the translation between GUI functions and mobile-home middleware modules.

All commands 716 from user interface input components 706 of the application, data, and media between application and middleware are processed through Message module 718 in mobile-home middleware. The Message module 718 passes the commands from the application, and converts them to an intermediate data structure to be sent to the Control module 720, which then converts the received information to a SIP compliant message. The message module also passes any messages data 714 and/or media data 712 received from Control module, interprets it, and sends it to the applications. These data include any short messages data 714 or media data 712 to be rendered in the application at windows 702 and/or 704. Control module 720 receives the commands from Message module 718 and packs them into SIP message body, or strips any data from SIP message body, and parses and converts to application data (intermediate data structure). Some user configuration data (such as server IP address, camera settings, alarm sensitivity etc.) are stored locally in Profile manager 722. SIP module 710 acts as SIP UA and directly communicates with other SIP UA or SIP server through SIP protocol. SIP module 710 can register the mobile-home middleware to the SIP server, and receives any SIP messages from other SIP devices through SIP server.

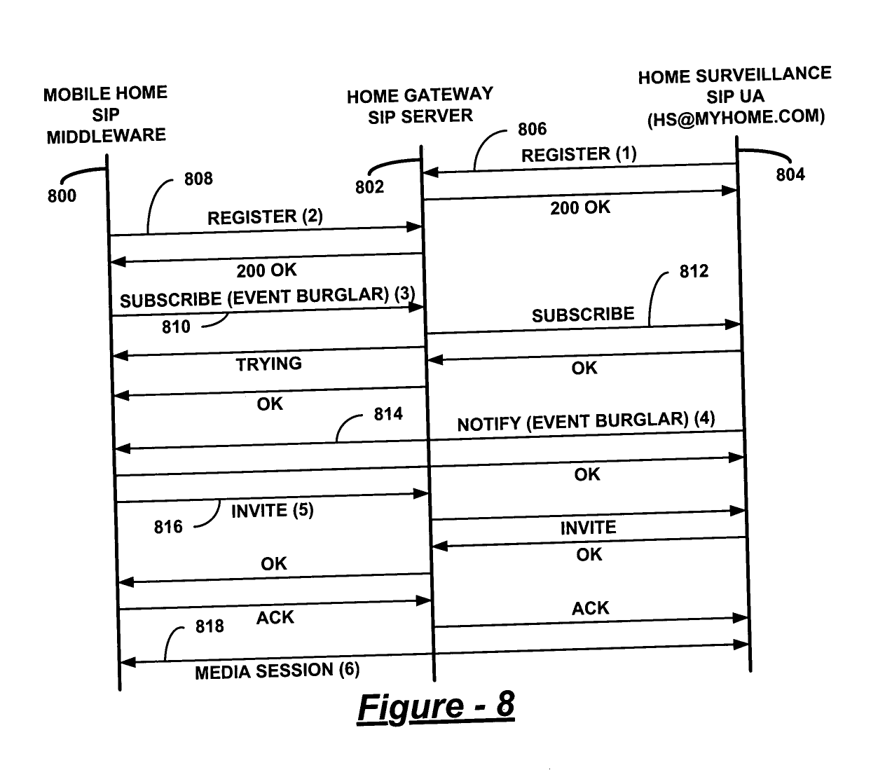

Turning now to FIG. 8, SIP signaling according to the invention can occur when the home surveillance SIP bridging registers itself with the Home Gateway SIP Server 802 (SIP Service on OSGi) and becomes a virtual SIP UA 804. By registering with SIP Service, it is also registered with OSGi framework. Therefore, the Home surveillance SIP UA 804 has both SIP capability and access to other OSGi bundles on the framework. Alternatively or additionally, SIP signaling can occur when mobile-home SIP middleware 800 registers to SIP server 802 and makes its SIP URL available to the server. For example, the SIP UA 804 registers itself with the server 802 and becomes a virtual SIP UA at 806. Additionally or alternatively, middleware 800 registers to SIP sever 802 at 808 and makes its SIP URL available to the server. Consider the following example message using UDP (user datagram protocol) as transport layer IP protocol to carry SIP messages. Another protocol such as TCP can also be used, but there is a delay associated with opening up a TCP connection.
REGISTER sip:sipserver.myhome.com SIP/2.0
Via SIP/2.0/UDP 4.3.2.1:5060
To: Matthew Ma <sip:mma@mymobile.com>
From: Matthew Ma <sip:mma@mymobile.com>
Contact: <sip:mma@4.3.2.1>;class=personal
. . .
Upon receipt from SIP server:
SIP/2.0 200 OK
Via: SIP/2.0/UDP 4.3.2.1:5060
To: Matthew Ma <sip:mma@mymobile.com>
From: Matthew Ma <sip:mma@mymobile.com>
Contact: <sip:mma@4.3.2.1>;class=personal;expires=3600
. . .

Notice that the 200 OK response to a REGISTER echoes the contact URL that have been successfully registered.

In another example, the mobile-home SIP middleware subscribes to the Home surveillance SIP UA and specifies the “Burglar” event at 810 and 812. Consider the following example message:

SUBSCRIBE sip:hs@myhome.com SIP/2.0
Via: SIP/2.0 UDP 4.3.2.1
To: Home Surveillance <sip:hs@myhome.com>
From: Matthew Ma <sip:mma@mymobile.com>
Event: Burglar
. . .

In a further example, upon burglar event, Home surveillance SIP UA notifies Mobile-Home SIP middleware at 814. The sample messages can look like this:
NOTIFY sip:mma@mymobile.com SIP/2.0
Via: SIP/2.0/UDP 198.162.1.100:5060
To: Matthew Ma <sip:mma@mymobile.com>
From: Home Surveillance <sip:hs@myhome.com>
Event: Burglar
. . .

In a still further example, Mobile-Home SIP middleware invites Home surveillance SIP UA for a real-time media session to monitor video at 816. The sample message can look like this:
INVITE sip:hs@myhome.com SIP/2.0
Via: SIP/2.0/UDP 4.3.2.1:5060
To: Home Surveillance <sip:hs@myhome.com>
From: Matthew Ma <sip:mma@mymobile.com>
Contact: <sip:mma@4.3.2.1>
. . .

Optionally, the INVITE message can carry a SDP body to specify media negotiation such as RTP.

Finally, upon acknowledgment of both parties, a video session is established between Mobile-Home SIP middleware and Home surveillance SIP UA at 818, and the user can monitor the home on a mobile device.

Examples of Java Objects for remote applications are supplied below in pseudocode.

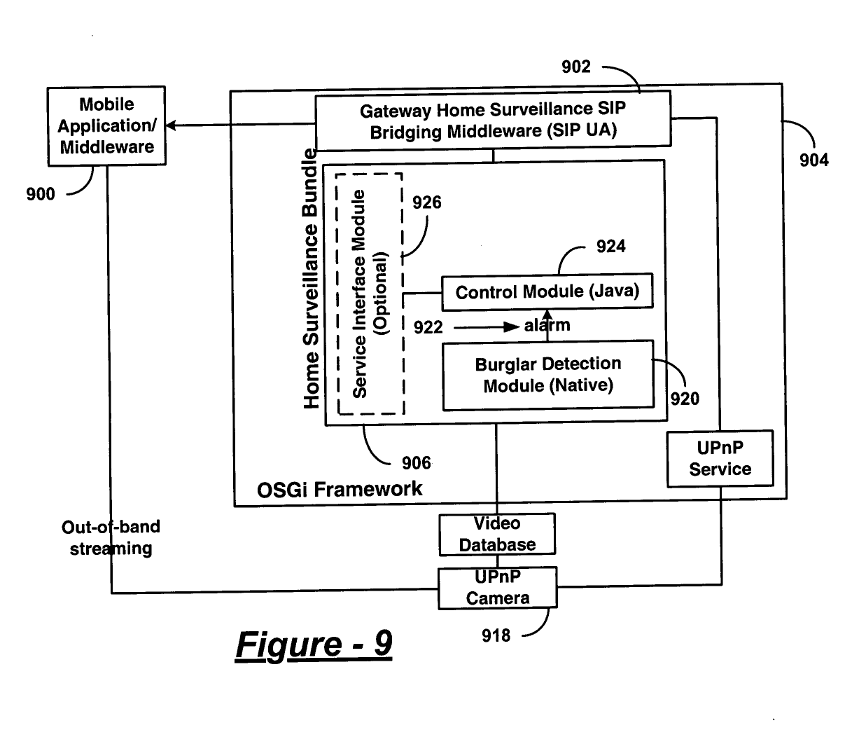

Turning now to FIG. 9, the home surveillance bundle 906 on OSGI framework 904 is an OSGi compliant application that analyzes video contents captures from the UPnP camera 918 and monitors any intrusion through burglar detection module 920. A simple motion detection algorithm can be used to detect a burglar and send an alarm 922 through the control module 924 to the mobile user application 900.

Optionally, the home surveillance bundle can implement a service interface module 926 that accepts control commands from the mobile user application 900 to take any actions to respond to the burglar alarm. For example, the user can tell the service interface module to contact other members in the family, notify security service providers or directly dial to police etc.

While the control module is a Java API that allows other OSGi bundles to share its functionality, the burglar detection module can be written in native language for performance. OSGi frameworks support the native environment. The home surveillance bundle can be used by other bundles on the OSGi framework, or the mobile device through home surveillance SIP bridging middleware 902.

The gateway home surveillance SIP bridging middleware acts as an activator of the home surveillance bundle for SIP. This SIP bridging itself can be an OSGi bundle. Upon start, SIP bridging registers to the SIP service (proxy) on OSGi gateway and become a SIP UA. By way of SIP service registration, it is automatically registered to the OSGi framework, which allows it to have access to other OSGi bundles including Home Surveillance Bundle. Since it becomes a SIP UA, it is accessible by other SIP UAs including mobile device on the SIP network. Subsequent SIP communication between mobile device and home surveillance SIP bridging middleware can be used to send/receive data and commands from the mobile device to home surveillance service. SIP commands from a mobile device are translated so appropriate home surveillance bundle control functions can be called. Similarly, any status/data and notification (alarm) from the home surveillance bundle control module are packed into appropriate SIP messages and sent to the mobile device.

SIP-UPnP and SIP-1394 Bridging can alternatively or additionally be implemented. Accordingly, home surveillance and device control SIP bridging middleware can directly query device capabilities (state variables) or control such device accordingly. This direct query and control can be done through SIP-UPnP or SIP-1394 bridging. SIP messages are translated to appropriate function calls to work with OSGi UPnP service or OSGi 1394 control bundle, and vice versa.

The discovery and registration of UPnP devices on the OSGi framework is automatically implemented by the UPnP Service that is included in OSGi release 3. Similar functionalities are also expected in OSGi 1394 control bundle.

Examples of Java Objects for Home Surveillance and SIP Bridging are provided below in pseudocode.

```
class UAConfig
{
  //void setConfigFilePath (String configFilePath);
  //String getConfigFilePath ( );
  void setOutBoundProxyIP( String outBoundProxyIP );
  String getOutBoundProxyIP( );
  void setOutBoundProxyPort( int outBoundProxyPort );
  int getOutBoundProxyPort( );
  void setRegistrarIP( String registrarIP );
  String getRegistrarIP( );
  void setRegistrarPort( int outRegistrarPort );
  int getRegistrarPort( );
  void setContactIP( String contactIP );
  String getContactIP( );
  void setContactPort( int contactPort );
  int getContactPort( );
  void setContactTransport( String Transport );
  String getContactTransport( );
  void setContactURI ( String mobileURI );
  String getContactURI ( );
}
class Buddy
{
  void setBuddySIPServiceID(String ID);
  String getBuddySIPServiceID( );
  void setBuddyURI(String buddyURI);
  String getBuddyURI( );
  void setBuddyAppName(String buddyAppName);
  String getBuddyAppName( );
  void setBuddyAppType(String buddyAppType);
  String getBuddyAppType( );
  /**
  *Matrix of BuddyServiceList:
  *first dimension is for { subscribe, invite, etc}
  *second dimension is description of service
  */
  String [ ][ ] getBuddyServiceList( );
  void setBuddyServiceList(String [ ][ ] buddyServiceList);
}
class BuddyList
{
  Vector getBuddyList(String SIPServiceID);
  Vector getBuddyList(String SIPServiceID, String buddyAppType);
  Buddy getBuddy(String buddyURI);
  void addBuddy(Buddy buddy);
  String [ ] getBuddyTypeList(String SIPServiceID);
}
/** Home surveillance SIP middleware is handled by CommandSet and
MediaSet.
*/
interface Command{
  boolean register( String SIPServiceID );
  boolean unregister( String SIPServiceID );
  }
class CommandSet implements Command{
  /**
  *Description:
  *Register or unregister with SIP server
  *Reference:
  *SIPServiceID:specified SIP server proxy.
  */
  /**
  *SIPBridging Usage Example:
  *When SIP Bridging starts on the OSGi Home-Network, it will invoke
one registerd
  *service of corresponding App Bundle on Framework. If service is
  available,
  *SIP Bridging will invoke register( ) method. On the other hand, SIP
Bridging
  *registers unregister( ) method on the Framework for corresponding App
  *Bundle, which allows the App Bundle to stop on Framework after its
necessarily
  *unregistered.
  */
  boolean register( String SIPServiceID );
  boolean unregister( String SIPServiceID);
/**
  *Description:
  *Send notify to mobile application, which is generated by the services
subscribed
  *by the mobile.
  *Reference:
  *appName: application name on the mobile.
  *typeOfEvent: event to be notified.
  *XMLData: description of notify.
  */
  /**
  *AppBun Usage Example:
  *When intruder is detected, Home Surveillance service bundle should
  invoke notify( )
  *method to send alarm to the remote mobile.
  */
  boolean notify(String appName, String typeOfEvent, String XMLData);
  }
  class DataSet{
  /**
  *Description:
  *Send XML data to specified application on mobile.
  *Reference:
  *appName: mobile.
  *XMLData: XML data
  */
  synchronized boolean sendMessage(String appName, String XMLData);
  /**
  *Description:
  *Pass XML data, which is received from mobile, to application on
  *Home-Network.
  *Reference:
  *buddyURI:mobile.
  *XMLData: XML data.
  */
  void receiveMessage(String buddyURI, String XMLData);
}
class MediaSet{
  /**
  *Description:
  *start and stop sending multimedia to application on mobile.
  *Reference:
  *AppName: specified application on mobile.
  *TypeOfInvite: {video, audio, image}
  */
  /**
  *Usage Example:
  *On receiving video requesting or video bye, the corresponding module
  uses
  *startSendVideo( ) or stopSendVideo( ) method to send or terminate the
video stream to mobile.
  */
  void startSendVideo(String appName, string typeOfFormat);
  void stopSendVideo(String appName, string typeOfFormat);
}
```

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A networked mobile home surveillance system, comprising:
a home surveillance application running on a user device to accesses services on a home network and receive data from the home network;
a home network gateway using SIP messaging to allow communication of commands and data on the user device to and from a home networked device through bridging between SIP and a non-SIP protocol of the home network; and
a home surveillance service on the home network, said service controlling home networked remote devices used to monitor the home, and being subject to control by said application.

2. The system of claim 1, wherein said service is adapted to send data and media to said application.

3. The system of claim 1, wherein said service is adapted to monitor the home via a remote camera and detect one or more configurable events.

4. The system of claim 3, wherein said service is adapted to send one or more notifications to said application upon detection of one or more of the events.

5. The system of claim 1, wherein said service is adapted to allow said application to request additional services, including at least one of control of a camera, triggering a sprinkler system in the home, or making 911 calls.

6. The system of claim 1, wherein the portable device includes said applications with GUI, a wireless interface, middleware, and a network stack enabling the device to communicate with the home network via SIP protocol, therefore acting as a SIP UA (user agent) from the SIP network perspective.

7. The system of claim 1, wherein said home network gateway includes a middleware to convert SIP signaling protocols to home networking specific functions.

8. The system of claim 7, wherein the middleware receives messages from said application, and converts them to SIP commands, and also receives SIP messages and events and sends relevant messages to the mobile application.

9. The system of claim 1, further comprising a SIP server that is an intermediary device located within a SIP-enabled network connecting the portable device and the home network and assisting user agents, including the portable device, in session establishment and other functions.

10. The system of claim 1, wherein said home network gateway provides a basic framework for networked devices to be able to communicate and control each other.

11. The system of claim 1, wherein said home network gateway includes a bridging module that serves as an adaptor to allow devices and services (applications) on the home network gateway to possess SIP capability that allows them to communicate with other SIP devices in a remote location via a SIP server/proxy.

12. The system of claim 11, wherein the bridging module takes the form of a SIP stack retrofitted to said home network gateway.

13. The system of claim 11, wherein the bridging module takes the form of a SIP service designed to handle mobility and inter-gateway bridging of devices operating according to a non-SIP service discovery protocol, the service providing WAN communication of SIP Devices; device and service application-layer mobility, and inter-gateway bridging.

14. The system of claim 1, wherein SIP bridging for said home surveillance service is provided within SIP middleware of said home network gateway to allow other SIP devices to access said home surveillance service by converting events to SIP methods and events.

15. The system of claim 1, wherein SIP device bridging provides capabilities for said home surveillance service to be able to control devices operating according to the other service discovery protocol of the home network, and still another service discovery protocol of another device by converting SIP commands/messages/events to those of the still other protocol, therefore allowing said home surveillance service to control the other device on a framework of the home network.

16. The system of claim 1, wherein home surveillance SIP bridging registers itself with a home gateway SIP server and becomes a virtual SIP UA 804.

17. The system of claim 1, wherein SIP middleware registers to a SIP server and makes its SIP URL available to the server, thereby becoming a virtual SIP UA.

18. The system of claim 1, wherein SIP middleware is adapted to subscribe to a home surveillance SIP UA and specify a “Burglar” event.

19. The system of claim 18, wherein the home surveillance SIP UA, upon burglar event, is adapted to send a notification to the SIP middleware.

20. The system of claim 19, wherein the SIP middleware, in response to the notification, is adapted to invite the home surveillance SIP UA for a real-time media session to monitor video, thereby establishing a video session between the SIP middleware and the home surveillance SIP UA, and allowing a user to monitor the home via the user device.

21. A device for use with a networked mobile home surveillance system, the device comprising:
one or more applications with graphical user interface components adapted to send home surveillance service commands to a home network via SIP and display at least one of an alarm or media received from the home network via SIP;
an interface for communicating with a SIP enabled network; and
a network stack enabling said device to communicate with the home network via SIP protocol, therefore acting as a SIP UA (user agent) from the SIP network perspective.

22. The device of claim 17, wherein one or more of said applications is adapted to communicate with the home network and stream media from remote devices connected to the home network, utilize related services, and control the devices.

23. The device of claim 17, further comprising SIP middleware at least one of converting SIP signaling protocols to home networking specific functions or receiving SIP messages and events and sending relevant messages to one or more of said applications.

24. The device of claim 17, wherein said middleware receives messages from one or more of said applications, and converts them to SIP commands for transmission over said SIP enabled network.

25. The device of claim 17, wherein said middleware is adapted to receive SIP messages and events from said SIP enabled network and send relevant messages to one or more of said applications.

26. A home network for use with a mobile home surveillance system, the network comprising:
a home network gateway using SIP messaging to allow communication of commands and data on a user device to and from a home networked device through bridging between SIP and a non-SIP protocol of the home network; and
a home surveillance service on the home network, said service controlling home networked remote devices used to monitor the home, and being subject to control by the mobile application.

27. The network of claim 26, wherein said service is adapted to send data and media to said application.

28. The network of claim 26, wherein said service is adapted to monitor the home via a remote camera and detect one or more configurable events.

29. The network of claim 28, wherein said service is adapted to send one or more notifications to said application upon detection of one or more of the events.

30. The network of claim 26, wherein said service is adapted to allow said application to request additional services, including at least one of control of a camera, triggering a sprinkler system in the home, or making 911 calls.

31. The network of claim 26, wherein the additional services include at least one of control of the camera, triggering a sprinkler system in the home, or making 911 calls.

32. The network of claim 26, wherein said home network gateway includes a middleware to convert SIP signaling protocols to home networking specific functions.

33. The network of claim 32, wherein the middleware receives messages from a mobile application and converts them to SIP commands, and also receives SIP messages and events and sends relevant messages to the mobile application.

34. The network of claim 26, further comprising a SIP server that is an intermediary device located within a SIP-enabled network connecting a portable device and the home network and assisting user agents, including the portable device, in session establishment and other functions.

35. The network of claim 26, wherein said home network gateway provides a basic framework for networked devices to be able to communicate and control each other.

36. The network of claim 26, wherein said home network gateway includes a bridging module that serves as an adaptor to allow devices and services (applications) on the home network gateway to possess SIP capability that allows them to communicate with other SIP devices in a remote location via a SIP server/proxy.

37. The network of claim 36, wherein the bridging module takes the form of a SIP stack retrofitted to said home network gateway.

38. The network of claim 36, wherein the bridging module takes the form of a SIP service designed to handle mobility and inter-gateway bridging of devices operating according to a non-SIP service discovery protocol, the service providing WAN communication of SIP Devices; device and service application-layer mobility, and inter-gateway bridging.

39. The network of claim 26, wherein SIP bridging for said home surveillance service is provided within SIP middleware of said home network gateway to allow other SIP devices to access said home surveillance service by converting events to SIP methods and events.

40. The network of claim 26, wherein SIP device bridging provides capabilities for said home surveillance service to be able to control devices operating according to the other service discovery protocol of the home network, and still another service discovery protocol of another device by converting SIP commands/messages/events to those of the still other protocol, therefore allowing said home surveillance service to control the other device on a framework of the home network.
